(19) United States
(12) Patent Application Publication
(10) Pub. No.: US 2017/0241175 A1
(43) Pub. Date: Aug. 24, 2017

(54) FURNITURE HINGE

(71) Applicant: Julius Blum GmbH, Hoechst (AT)

(72) Inventor: André HAMMERER, Alberschwende (AT)

(21) Appl. No.: 15/590,630

(22) Filed: May 9, 2017

Related U.S. Application Data
(63) Continuation of application No. PCT/AT2015/000130, filed on Oct. 9, 2015.

(30) Foreign Application Priority Data
Dec. 9, 2014 (AT) A 881/2014

(51) Int. Cl. E05D 3/14; E05F 1/12; E05F 5/00; E05D 11/10

(52) U.S. Cl. CPC E05D 3/142; E05D 11/1021; E05F 1/1253; E05F 5/006; E05D 3/14; E05D 3/06

(57) ABSTRACT

A furniture hinge for pivotally connecting at least two furniture parts to one another, including: at least two fastening portions which are pivotally connected to one another for fastening to the furniture parts, wherein the fastening portions can be moved relative to each other between a closed position and an open position, a spring device for pressing the fastening portions into the closed position and/or into the open position, a damping device for dampening a relative movement of the fastening portions, wherein the spring device is integrated into the damping device, wherein the damping device and the spring device are accommodated within a first and within a second housing portion, wherein the first and second housing portions, for performing the relative movement, are displaceably arranged relative to one another.

The present invention relates to a furniture hinge for pivotally connecting at least two furniture parts to one another, including:
at least two fastening portions which are pivotally connected to one another for fastening to the furniture parts, wherein the fastening portions can be moved relative to each other between a closed position and an open position,
a spring device for pressing the fastening portions into the closed position and/or into the open position,
a damping device for dampening a relative movement of the fastening portions, wherein the spring device is integrated into the damping device.

WO 2010/124946 A1 shows a damping device for furniture hinges, wherein a piston is displaceably arranged within an inner space of a housing. For acting a pressure to the piston, a piston rod is provided which protrudes out of the housing and which is coupled via a connecting element to a hinge pin of a furniture hinge. Upon a movement of the hinge, the piston rod thus is being pressed-in by way of the moving hinge pin, so that said movement of the hinge takes place in a dampened manner. In order to press the furniture hinge into the fully closed position, a spring-assisted closing mechanism (which is not shown in WO 2010/124946 A1) needs to be provided. However, the additional arrangement of such a closing mechanism would result in an increased installation space and an additional installation effort.

Hinge fittings, where the spring device and the damping device are in each case integrated into a common structural unit, are described, for example, in AT 5290 U1, EP 2 336 467 A1, AT 413 728 B, U.S. Pat. No. 6,327,457 B1 and in US 2004/0040118 A1.

It is an object of the present invention to provide a furniture hinge of the type mentioned in the introductory part, having a more compact structure.

This is accomplished by the features of patent claim 1. Further advantageous configurations of the invention are defined in the dependent subclaims.

According to the invention, it is thus provided that the damping device and the spring device are accommodated within a first and a second housing portion, wherein the first and the second housing portions, for performing the relative movement, are displaceably arranged relative to one another.

In this way, a very compact design of the furniture hinge is effected, because the two housing portions, when the relative movement of the fastening portions is performed, can be linearly displaced along a predetermined direction of movement, wherein no veering movements of the housing portions occur.

Preferably, the first housing portion and the second housing portion are tensioned relative to one another by the force of the spring device, for example in such a way that the first housing portion and the second housing portion can be compressed relative to one another against the force of the spring device.

The spring device for moving the furniture hinge into the end position(s), together with the damping device for dampening a hinge movement, are jointly accommodated within a common functional constructional unit. Therefore, the furniture hinge can be equipped both with a closing mechanism and a damping function by the installation of a single, compact structural unit, wherein said constructional unit can also be retrofitted to already existing furniture hinges. In this way, a separate arrangement or attachment of a spring device and an additional damping device on the furniture hinge can be omitted.

The force of the spring device is naturally to be dimensioned in such a way that the furniture hinge can be reliably pressed by said spring force into the fully closed and/or into the fully open position. The spring device can include, for example, at least one helical spring, preferably a compression spring. Alternatively, also a tension spring, a torsion spring or a leaf spring may be provided.

The damping device can include at least one, preferably hydraulic, linear damper. Such linear dampers usually have a piston-cylinder-unit, wherein a relative movement between the cylinder and the piston can be dampened by a, in particular hydraulic, damping medium. Instead of a linear damper, also a rotational damper with two damping components being rotatable to one another may be provided.

Further details and advantages of the present invention result from the following description of figures in which:

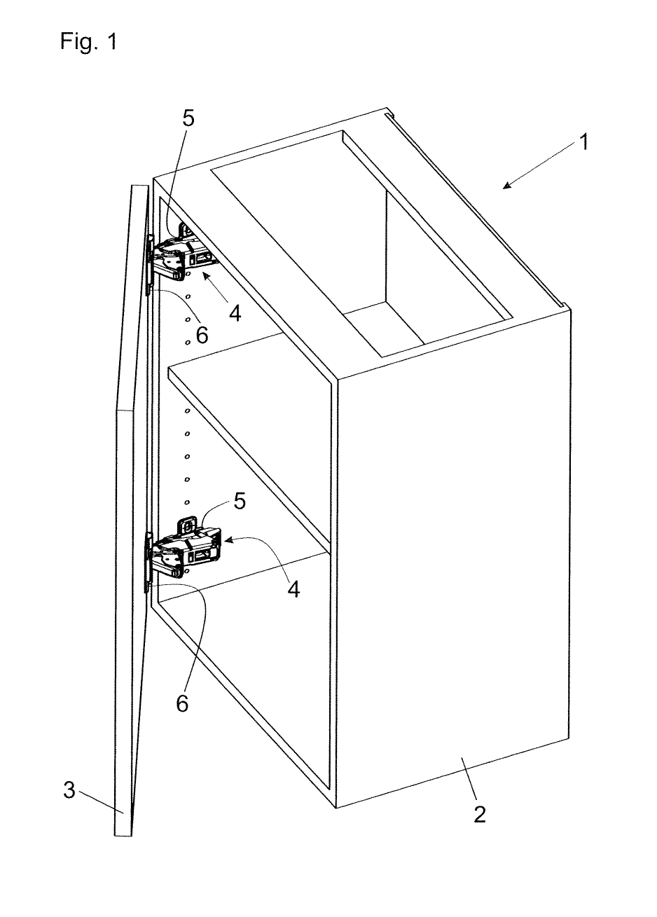

FIG. 1 shows a perspective view of an item of furniture having a furniture carcass and a furniture part being movable thereto,

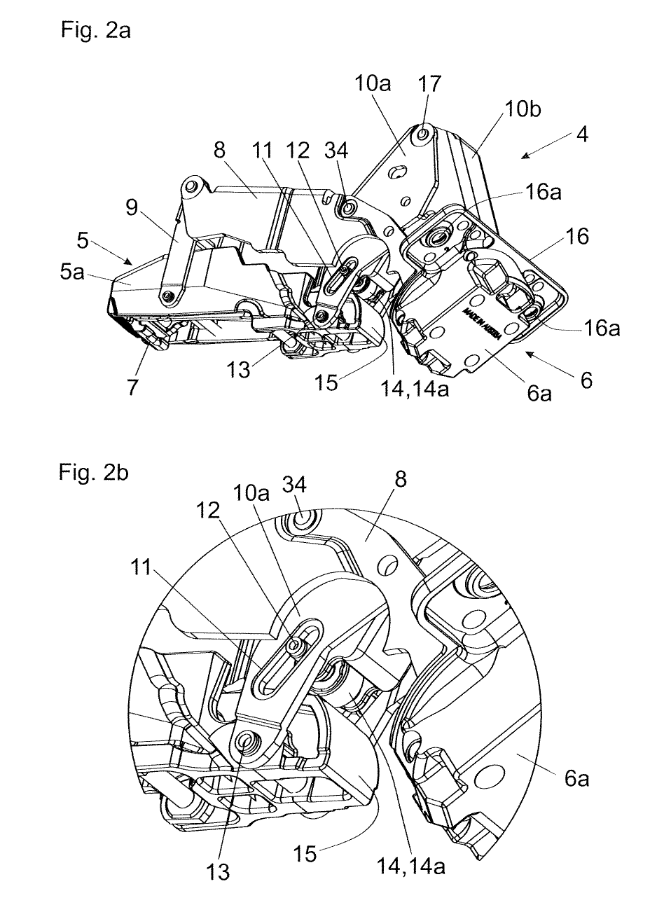

FIGS. 2a, 2b a perspective view of a furniture hinge and an enlarged detail view thereof,

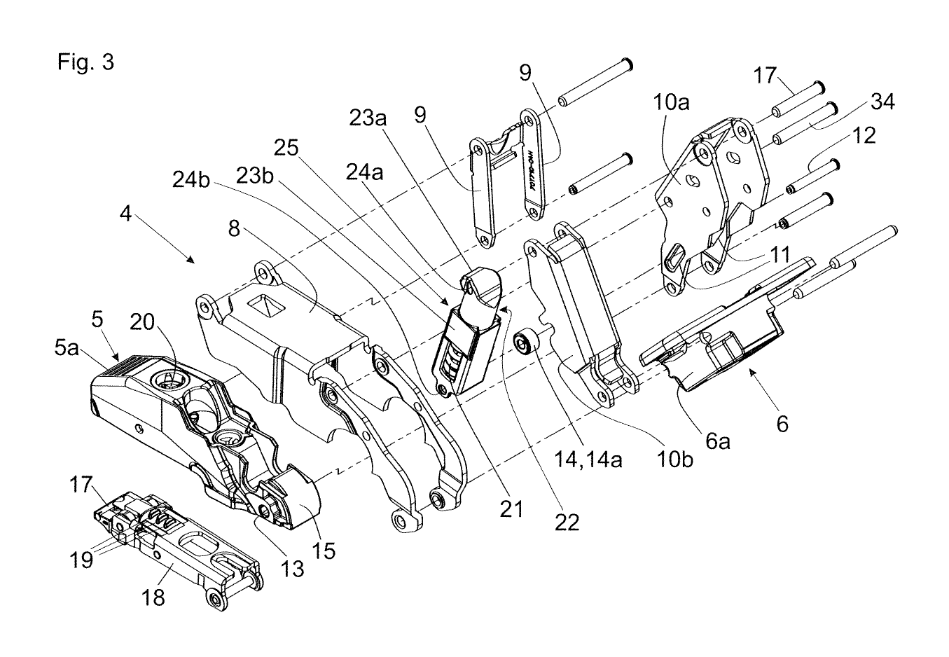

FIG. 3 an exploded view of the furniture hinge according to FIGS. 2a, 2b,

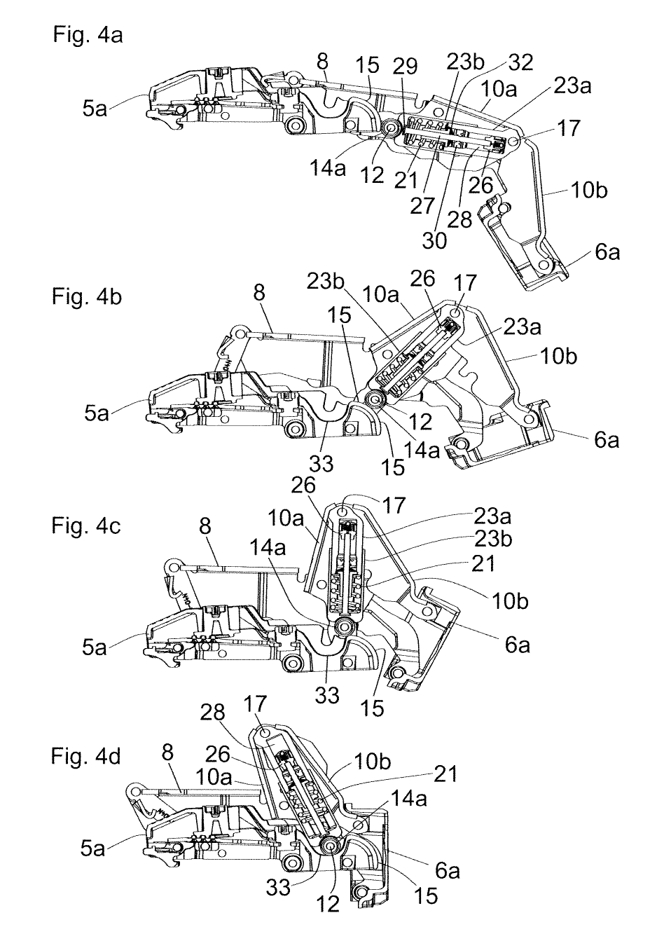

FIGS. 4a-4d the closing process of the furniture hinge in temporal sequences,

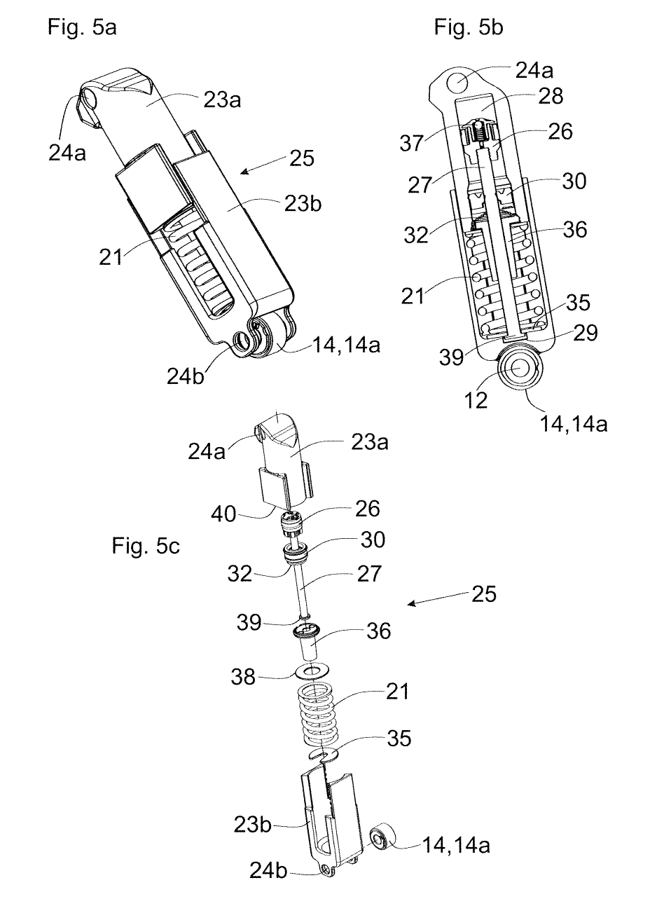

FIGS. 5a-5c the common structural unit in different views.

FIG. 1 shows an item of furniture 1 with a furniture carcass 2 in a perspective view, wherein a movable furniture part 3 in the form of a door is pivotally supported about a vertically extending axis by way of furniture hinges 4 relative to the furniture carcass 2. The furniture hinges 4 each have a first fastening portion 5 with a hinge arm 5a (FIG. 2a) to be fixed to the furniture carcass 2 and a second fastening portion 6 with a hinge cup 6a (FIG. 2a) to be fixed to the movable furniture part 3. The hinge cup 6a, as commonly known, can be countersunk in a cylindrical bore provided in the movable furniture part 3 and is pivotally connected to the first fastening portion 5 by way of a joint mechanism.

FIG. 2a shows the furniture hinge 4 in a perspective view. The furniture hinge 4 includes a first fastening portion 5 with a hinge arm 5a which can be releasably latched by a spring-loaded latching lever 7 onto a mounting plate to be fixed to the furniture carcass 2. A second fastening portion 6 with a hinge cup 6a to be countersunk in a cylindrical bore of the furniture part 3 is connected to the hinge arm 5a by way of a joint mechanism. The hinge cup 6a can be fixed to the movable furniture part 3 by way of a flange 16 which has openings 16a for the passage of screws. In the shown embodiment, the furniture hinge 4 is configured as a wide-angle hinge having a maximum opening angle of approximately 170°. For this purpose, an intermediate piece 8 which is motionally coupled to a hinge movement is provided, wherein the intermediate piece 8, on the one hand, is pivotally connected to the hinge arm 5a by way of levers 9 and, on the other hand, is pivotally connected to the hinge cup 6a. The joint mechanism further includes two hinged levers 10a and 10b which are connected to one another by a hinged pin 17. The first hinged lever 10a is pivotally connected via a pivoting axis 13 to the hinge arm 5a and, moreover, is pivotally connected via a further pivoting axis 34 to the intermediate piece 8, while the second hinged lever 10b is pivotally coupled to the hinge cup 6a. The first hinged lever 10a has a guide 11 (preferably a slotted recess) for allowing limited displacement of a bolt 12 on which a pressure portion 14 (preferably a pressure roller 14a which pivotally supported about the bolt 12) is arranged. The pressure portion 14 in the form of the pressure roller 14a can be moved, by a movement of the hinge 4, at least over a region along a setting contour 15, wherein in the shown embodiment, the setting contour 15 is arranged or formed on the hinge arm 5a. The pressure portion 14 in the form of the pressure roller 14a forms part of a common structural unit 25 (FIG. 3) by which the furniture hinge 4 can be moved into the fully closed position and/or fully open position by the force of a spring device 21 (FIG. 3) and wherein additionally a movement of the furniture hinge 4 into the closed position and/or open position can be dampened by a damping device 22 (FIG. 3). By the choice of the respective geometry of the setting contour 15, the operating start, the progression and the end of the spring force as well as the damping force can be determined in various configurations. FIG. 2b shows an enlarged detail view of the furniture hinge 4 according to FIG. 2a.

FIG. 3 shows the furniture hinge 4 in an exploded view. The fastening portion 5 with the hinge arm 5a can be connected to a base plate 18, wherein the hinge arm 5a can be adjusted relative to the base plate 18 in a longitudinal direction of the base plate 18 by a rotation of an adjusting wheel 20 which interacts with protrusions 19 of the base plate 18. The intermediate piece 8, which serves as a sort of extension for the hinge arm 5a for obtaining a greater opening angle of the furniture hinge 4 towards an open position, is one the one hand pivotally connected via levers 9 to the hinge arm 5a and on the other hand hingedly connected to the hinge cup 6a. The first hinged lever 10a is pivotally mounted about the pivoting axis 13 relative to the hinge arm 5a and is connected via a hinged pin 17 to the second hinged lever 10b. The other end of the second hinged lever 10b is hingedly connected to the hinge cup 6a.

A spring device 21—which preferably includes at least one compression spring—for moving the furniture hinge 4 into the fully closed position and/or open position and additionally a damping device 22 for dampening a movement of the furniture hinge 4 are accommodated within a common structural unit 25. The common structural unit 25 includes two housing portions 23a and 23b which are displaceable to one another and which are configured to be compressible to one another against the force of the spring device 21. The first housing portion 23a has a holder 24a for accommodating a hinged pin 17 which pivotally connects the two hinged levers 10a, 10b to one another. The second housing portion 23b includes a further holder 24b for accommodating the bolt 12 on which the pressure portion 14 in the form of the pressure roller 14a is supported. The holders 24a, 24b are each configured so as to entirely embrace the cylindrical hinged pin 17 and the bolt 12, respectively. However, the holders 24a, 24b may also be configured to be clamp-like, so that the holders 24a, 24b only partially embrace the hinged pin 17 and the bolt 12, respectively. In this way, the common structural unit 25 can be replaced in case of a defect or can be retrofitted. The common structural unit 25 with the damping device 22 and the spring device 21 integrated therein thus interacts, on the one hand, with the hinged pin 17 and, on the other hand, via the pressure roller 14a, with the setting contour 15 of the hinge arm 5a. Upon a movement of the furniture hinge 4, the hinged pin 17—together with the pressure portion 14—can be displaced along a guide 11 of the first hinged lever 10a. By this hinge movement, the first housing portion 23a is displaceable, preferably telescopically, relative to the second housing portion 23b, wherein by way of the damping device 22, an acceleration of the fastening portions 5, 6 relative to one another, caused by the spring device 21, can be dampened.

FIG. 4a-4d show the furniture hinge 4 in different positions of the fastening portions 5, 6 relative to one another. In FIG. 4a, the fully open position (approximately 170°) of the furniture hinge 4 is depicted, wherein the intermediate piece 8 and the two hinged levers 10a, 10b are in a fully stretched position. Visible is the common structural unit 25 (FIG. 3) in which the spring device 21 and the damping device 22 are jointly accommodated. The first housing portion 23a is supported on a hinged pin 17 which is motionally coupled to a movement of the hinge 4 and which engages telescopically into the second housing portion 23b, wherein the first and second housing portions 23a, 23b are tensioned relative to one another by the force of the spring device 21. Within the first housing portion 23a, at least one fluid chamber 28 is formed in which a piston 26 is displaceably supported. A piston rod 27 connected to the piston 26 is passed through the second housing portion 23b and is fixed to a stop 29 of the second housing portion 23b. The second housing portion 23b has a bolt 12 for pivotally supporting the pressure roller 14a which runs along a setting contour 15 being arranged on the hinge arm 5a. As shown in FIG. 4a, the piston 26 is fully pressed into the first housing portion 23a and is located in a ready position for the damping stroke, wherein thus the damping device 22 reacts on tensile force. The setting contour 15, over a large region of the closing path, can be formed such so that the section of the setting contour 15, which contacts the pressure roller 14a, runs equidistantly relative to the hinged pin 17. In other words, the setting contour 15 is configured so that there is no relative movement between the piston 26 and the fluid chamber 28 upon a large part of the closing path of the furniture hinge 4, so that also no damping action is being generated.

FIG. 4b shows the furniture hinge 4 with a further reduced opening angle in comparison to FIG. 4a. The pressure roller 14 runs along the setting contour 15 of the hinge arm 5a, wherein there is no relative movement between the piston 26 and the fluid chamber 28 and thus no damping action occurs.

FIG. 4c shows the furniture hinge 4 with a smaller opening angle in comparison to FIG. 4b. In the last closing region, the pressure roller 14a interacts with a trough-shaped section 33 of the setting contour 15, wherein said a trough-shaped section 33 has a greater relative spacing in relation to the hinged pin 17. When now the pressure roller 14a reaches into said trough-shaped section 33, the two housing portions 23a, 23b are pressed apart by the force of the relaxing spring device 21, so that the furniture hinge 4 is being pressed by the force of the spring device 21 into the fully closed position and wherein the piston 26 (the piston rod 27 of which is fixed to the second housing portion 23b) is being pulled-out of the fluid chamber 28 of the first housing portion 23a and is thereby being dampened by a resistance of a damping fluid (for example silicone oil) arranged within the fluid chamber 28. By way of this braking action of the piston 26, also a movement of the furniture hinge 4 into the closed end position can be dampened. In FIG. 4d, the furniture hinge 4 is in the fully closed position. In the event that the furniture hinge 4 should be pressed into the fully open position by the force of the spring device 21, such a trough-shaped recess 33 of the setting contour 15 needs to be arranged also in that region in which the pressure roller 14a, according to the position shown in FIG. 4a, interacts with the setting contour 15. Besides the force progression acting on the furniture hinge 4, the setting contour 15 determines at the same time also the transmission ratio of the damping device 22.

FIG. 5a shows the common structural unit 25 in a perspective view. The damping device 22 is accommodated within the first housing portion 23a, while the spring device 21 is accommodated within the second housing portion 23b. The two housing portions 23a, 23b can be compressed to each other against the force of the spring device 21. The holder 24a is provided for accommodating the hinged pin 17 of the furniture hinge 4, while the holder 24b is provided for supporting the pressure portion 14 in the form of the pressure roller 14a.

FIG. 5b shows the common structural unit 25 in a cross-section. Within the first housing portion 23a, at least one fluid chamber 28 is arranged in which a linearly displaceable piston 26 is disposed. The piston 26 is equipped with an overload protection 37 having a spring-loaded ball which, upon an unduly application of pressure acting on the piston 26, releases an overload channel of the piston 26 and therewith enables a rapid pressure reduction. A piston rod 27 connected to the piston 26 is passed through the second housing portion 23b and is attached to a stop 29 of the second housing portion 23b. The attachment of the piston rod 27 to the stop 29 is effected by a widened head 39 of the piston rod 27 which is held on the stop 29 by a disc 35 and by the force of the spring device 21 in the form of a compression spring. The fluid chamber 28 is closed in a fluid-tight manner by a cap 36 which serves at the same time as a guide or support for the spring device 21. In the fluid chamber 28, a limitly movable seal 30 and a volume compensation device with a compensation spring 32 is arranged, wherein the compensation spring 32 takes up the different volume emerging from the displacement of the piston rod 27 by deformation.

FIG. 5c shows the common structural unit 25 in an exploded view. The widened head 39 of the piston rod 27 is being held by a disc 35 and by the force of the spring device 21 to the stop 29 (FIG. 5b) of the second housing portion 23b. The other end of the spring device 21 presses against a ring-shaped support disc 38 which rests against a front face 40 of the first housing portion 23a, so that the housing portions 23a and 23b can be compressed relative to one another against the force of the spring device 21.

1. A furniture hinge for pivotally connecting at least two furniture parts to one another, including:
at least two fastening portions which are pivotally connected to one another for fastening to the furniture parts, wherein the fastening portions can be moved relative to each other between a closed position and an open position,
a spring device for pressing the fastening portions into the closed position and/or into the open position,
a damping device for dampening a relative movement of the fastening portions, wherein the spring device is integrated into the damping device,
wherein the damping device and the spring device are accommodated within a first and within a second housing portion, wherein the first and second housing portions, for performing the relative movement, are displaceably arranged relative to one another.

2. The furniture hinge according to claim 1, wherein the damping device includes at least one, preferably hydraulic, linear damper.

3. The furniture hinge according to claim 1, wherein the spring device includes at least one helical spring, preferably a compression spring.

4. The furniture hinge according to claim 1, wherein the first housing portion and the second housing portion are tensioned relative to each other by the force of the spring device.

5. The furniture hinge according to claim 1, wherein at least one fluid chamber is formed within the first housing portion, wherein at least one piston is displaceably arranged within the fluid chamber.

6. The furniture hinge according to claim 5, wherein the piston is connected to a piston rod, wherein the free end of the piston rod is fixed to a stop of the second housing portion.

7. The furniture hinge according to claim 1, wherein the first housing portion has a holder for accommodating a hinged pin of the furniture hinge.

8. The furniture hinge according to claim 7, wherein the holder, preferably entirely, embraces the hinged pin.

9. The furniture hinge according to claim 7, wherein the hinged pin pivotally connects at least a first and at least one second hinged lever of the furniture hinge to one another.

10. The furniture hinge according to claim 9, wherein the first hinged lever is pivotally connected to an intermediate piece which is permanently coupled to a movement of the furniture hinge and that the second hinged lever is pivotally connected to one of the fastening portions.

11. The furniture hinge according to claim 1, wherein the second housing portion includes a pressure portion, preferably a pressure roller, wherein the pressure portion, upon a relative movement of the fastening portions to one another, is movable at least over a region along a setting contour.

12. The furniture hinge according to claim 11, wherein the setting contour is arranged or formed on one of the fastening portions.

13. The furniture hinge according to claim 11, wherein the pressure portion is arranged on a bolt, wherein said bolt is displaceably guided along a guide of a hinged lever upon a movement of the furniture hinge.

14. The furniture hinge according to claim 1, wherein the first fastening portion includes a hinge arm and that the second fastening portion includes a hinge cup.
